(19) United States
(12) Patent Application Publication
(10) Pub. No.: US 2016/0285576 A1
(43) Pub. Date: Sep. 29, 2016

(54) GATEWAY FOR INTERCONNECTION OF HETEROGENEOUS MIDDLEWARE AND TIME SYNCHRONIZATION METHOD THEREOF

(71) Applicant: ELECTRONICS AND TELECOMMUNICATIONS RESEARCH INSTITUTE, Daejeon-si (KR)

(72) Inventors: Kyeong Tae KIM, Daejeon-si (KR); Hyung Kook JUN, Daejeon-si (KR); Won Tae KIM, Chungcheongnam-do (KR); Woo Suk CHA, Jeollanam-do (KR)

(21) Appl. No.: 14/940,593

(22) Filed: Nov. 13, 2015

(30) Foreign Application Priority Data
Mar. 24, 2015 (KR) 10-2015-0040996

(51) Int. Cl. H04J 3/06; H04L 29/08

(52) U.S. Cl. CPC H04J 3/0673; H04L 67/28

(57) ABSTRACT

A gateway for interconnection of heterogeneous middleware includes a high level architecture (HLA) federate; a data distribution service (DDS) participant; a clock federate for a wall clock; and a time manger configured to synchronize times of the HLA federate and the DDS participant to the wall clock provided by the clock federate.

### CROSS REFERENCE TO RELATED APPLICATION

This application claims the benefit under 35 U.S.C. §119(a) of Korean Patent Application No. 10-2015-0040996, filed on Mar. 24, 2015, the entire disclosure of which is incorporated herein by reference for all purposes.

### BACKGROUND

1. Field

The following description relates to a communication middleware framework technology, and more specifically, to a technology for interconnection of heterogeneous middleware for exchanging data in an integrated simulation system.

2. Description of the Related Art

In a live, virtual and constructive (LVC) integrated simulation system, a live system for exchanging data uses data distribution service (DDS) middleware, and each of a virtual and a constructive systems use high level architecture (HLA) middleware.

The DDS middleware provides data service standards that support real-time performance, stability, and scalability of a real-time system based on a publish/subscribe model in a distributed environment, and the HLA middleware provides general-use architecture standards for a distributed processing computer simulation system.

Here, the HLA is a concept of high-level for interoperation between heterogeneous simulators and relates to the IEEE 1516 standards. Runtime infrastructure (RTI) is software that implements the HLA in the form of library. In the RTI, time management service is an important part for time synchronization among simulators. This is an important clue to sequentially process messages by identifying sequencing of messages containing information about event occurrence timing. In order to identify sequencing of the messages for the time management service of the RTI, a greatest available logical time (GALT) computation algorithm is used, which gradually advances time and processes a message of a corresponding timing. However, the time management service used in the RTI does not support the concept of real-time, and hence cannot provide real-time synchronization among simulations. Also, during the execution of GALT algorithm computation, time may advance faster or slower depending on the circumstances, and hence interconnection with a live system is not possible.

### SUMMARY

Accordingly, in one aspect, there is provided a gateway for interconnection of heterogeneous middleware for real-time synchronization among simulations, and a time synchronization method of the gateway.

In one general aspect, there is provided a gateway for interconnection of heterogeneous middleware including: a high level architecture (HLA) federate; a data distribution service (DDS) participant; a clock federate for a wall clock; and a time manger configured to synchronize times of the HLA federate and the DDS participant to the wall clock provided by the clock federate.

In another general aspect, there is provided a time synchronization method in a gateway for interconnection of heterogeneous middleware, the time synchronization method including: determining policies for transmission/reception of messages according to time order of a high level architecture (HLA) federate and a data distribution service (DDS) participant; granting the HLA federate and the DDS participant their requested time advance in order to allow the HLA federate and the DDS participant to sequentially transmit and receive messages according to the determined policies; and supporting conversion of logical time to allow the HLA federate and the DDS participant to synchronize their time to a wall clock provided by a clock federate such that the HLA federate and the DDS participant are synchronized with each other.

Other features and aspects will be apparent from the following detailed description, the drawings, and the claims.

### BRIEF DESCRIPTION OF THE DRAWINGS

FIG. 1 is a diagram illustrating a gateway for real-time synchronization to support live system interconnection a according to an exemplary embodiment.

FIG. 2 is a flowchart illustrating the time synchronization of the gateway to the DDS participant according to an exemplary embodiment.

FIG. 3 is a block diagram illustrating a time manager of a gateway according to an exemplary embodiment.

FIG. 4 is a flowchart illustrating a real-time synchronization method for supporting live-system interconnection according to an exemplary embodiment.

Elements, features, and structures are denoted by the same reference numerals throughout the drawings and the detailed description, and the size and proportions of some elements may be exaggerated in the drawings for clarity and convenience.

### DETAILED DESCRIPTION

The exemplary embodiments now will be described more fully hereinafter with reference to the accompanying figures. In the following description, a detailed description of known functions and configurations incorporated herein will be omitted when it may obscure the subject matter with unnecessary detail. Terms used throughout this specification are defined in consideration of functions according to exemplary embodiments, and can be varied according to a purpose of a user or manager, or precedent and so on. Therefore, definitions of the terms should be made on the basis of the overall context.

Terms used herein are defined below.

Simulation: A method for implementing a model, which is developed from modeling, over time, and providing a means for research, investigation, and analysis of various issues

High Level Architecture (HLA): software architecture that allows simulations which have been developed by different organizations for different purposes to be combined into one integrated simulation, and it relates to virtual and constructive simulations in a live, virtual, and constructive (LVC) integrated simulation system

HLA middleware: general-use architecture standard for a distributed processing computer simulation system

HLA federation: a simulation system set consisting of connected element simulations

HLA federate: individual simulation system for a federation

Federation object model (FOM): data produced by a federation developer or user and defining types of data and relationship between said data which are exchanged among federates for executing one federation

Runtime infrastructure (RTI): software in the form of library used for a federation

Object class: data object of HLA

Data distribution service (DDS): real-time system standards, related to “Live” of an LVC integrated simulation system

DDS middleware: Data service standards that support real-time performance, stability, and scalability of a real-time system based on a publish/subscribe model in a distributed environment

DDS domain: a real-time system set in which distributed systems are coupled to each other

DDS domain participant: individual real-time system for DDS domain

Topic: data object of DDS

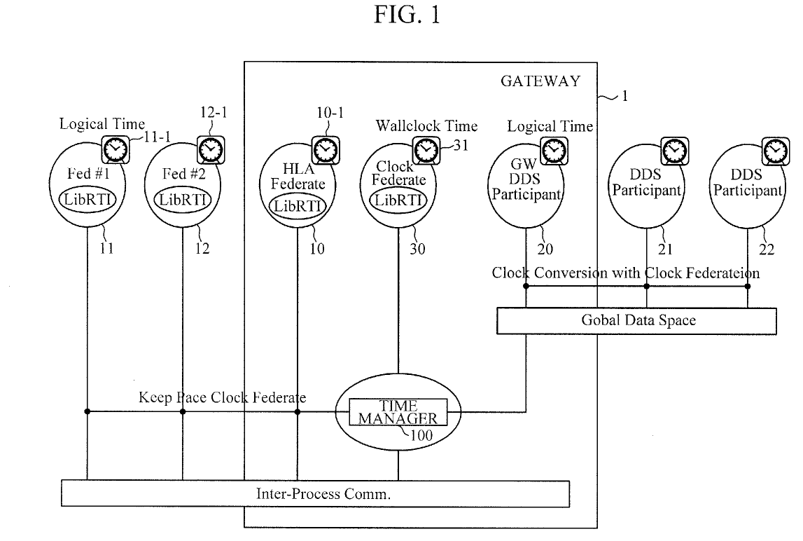

FIG. 1 is a diagram illustrating a gateway for real-time synchronization to support live system interconnection a according to an exemplary embodiment.

Referring to FIG. 1, a gateway 1 for interaction between DDS and HLA includes an HLA federate 10, a DDS participant 20, a clock federate 30, and a time manager 100.

To build Live, Virtual, and Constructive (LVC) integrated simulation system (hereinafter, will be referred to as an “LVC integrated simulation system), a DDS domain and an HLA domain have to be connected to each other. The gateway for interconnection between DDS and HLA supports interconnection between DDS middleware and HLA middleware. The gateway 1 provides functions related to interconnection, such as time synchronization, federation management, and FOM management, and the present disclosure is characterized by a time synchronization function.

The gateway 1 connects heterogeneous DDS middleware domain and HLA middleware domain to each other, and relays data exchange between the HLA federate 10 and the DDS participant 20 through data conversion. For example, the gateway 1 converts HLA data entities into DDS data entities, and provides the resulting DDS data entities to the DDS participant 20, or the gateway 1 converts DDS data entities into HLA data entities and provides the resulting HLA data entities to the HLA federate 10. The HLA federate 10 serves as an agent in HLA middleware domain, and the DDS participant 20 serves as an agent in DDS middleware domain.

According to one exemplary embodiment, the HLA federate 10 establishes a communication link from HLA middleware domain to other HLA federates 11 and 12, and transmits and receives object class, which is a data object, to and from the other HLA federates 11 and 12. The HLA federate 10 may deliver the data entities from the other HLA federates 11 and 12 to the DDS participant 20.

The DDS participant 20 may establish communication links from the DDS middleware domain to other DDS participants 21 and 22, and sets a quality of service (QoS) attribute of each entity in the DDS middleware domain. The DDS participant 20 transmits and receives topics, which are data entities, to and from the other DDS participants 21 and 22, and delivers the topics from the other DDS participants 21 and 22 to the HLA federate 10.

The gateway 1 supports time synchronization between the HLA middleware domain and the DDS middleware domain. To this end, when the HLA federates 10, 11, and 12 and the DDS participants 20, 21, and 22 exchange their generated messages with each other, the gateway 1 identifies the sequencing of the messages and performs relevant processing. To do so, the gateway 1 includes a clock federate 30 that has a wall clock time 31.

The time manager 100 distributes a wall clock time of the clock federate 30 to the DDS participants 20, 21, and 22, so that clock synchronization can occur, whereby the DDS participants 20, 21, and 22 synchronize their time to the wall clock time. In one exemplary embodiment, the wall clock time is distributed to the DDS participants 20, 21, and 22 by sending a Liveliness message, which is a QoS used by the DDS.

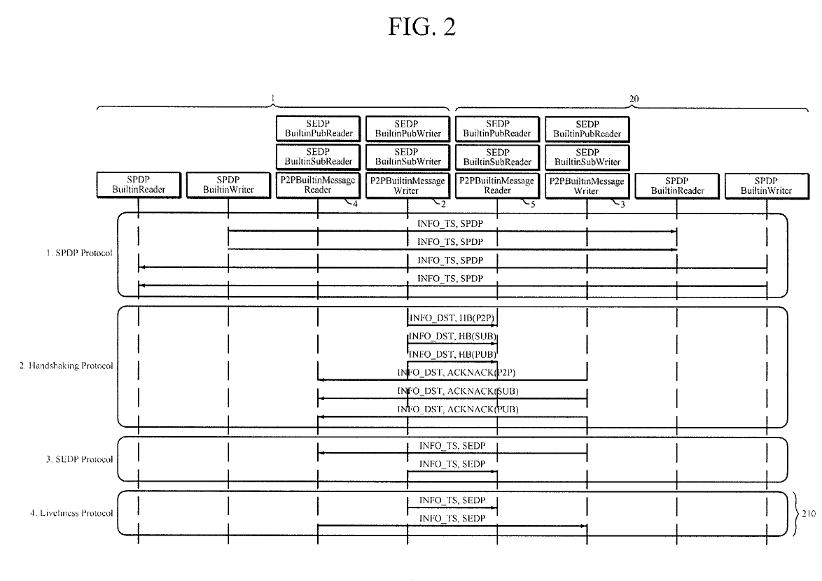

FIG. 2 is a flowchart illustrating the time synchronization of the gateway to the DDS participant according to an exemplary embodiment.

FIG. 2 shows object discovery process between the gateway 1 and the DDS participant 20. The object discovery process includes SPDP protocol, handshaking protocol, SEDP protocol, and Liveliness protocol. Time stamp information is delivered using Liveliness protocol 210. The other protocols are not within the scope of the present disclosure, and hence detailed descriptions thereof will be omitted.

An entity that transmits and receives Liveliness message is BuiltinEntity. BuiltinEntity uses ETITIYD_P2P_BUILTIN_PARTICIPANT_MESSAGE_WRITER(2, 3) and ENTITIYD_P2P_BUILTIN_PARTICIPANT_MESSAGE_READER(4, 5), and QoS value used is shown in Table 1 below.

TABLE 1

reliability.kind = RELIABLE_RELIABLITY_QOS
durablity.kind = TRANSIENT_LOCAL_DURABLITY
history.kind = KEEP_LAST_HISTORY_QOS
history.depth = 1

A Liveliness message of PaticipantMessageData type is used, consisting of GUID_t and data octets. The wall clock time stamp value of the gateway 1 is included in the data octets. The DDS participant 20 that has received the Liveliness message replaces its current time with the wall clock time stamp value of the Liveliness message.

When any of logical clocks 10-1, 11-1, and 12-1 of the respective HLA federates 10, 11, and 12 advances its time (slowly or quickly according to circumstances), the time manager 100 supports the logical clocks to keep pace with the wall clock time of the gateway

Accordingly, the advancing speeds of the HLA federates 10, 11, and 12 and the DDS participants 20, 21, and 22 are consequently synchronized with each other, so that real-time time synchronization therebetween is possible.

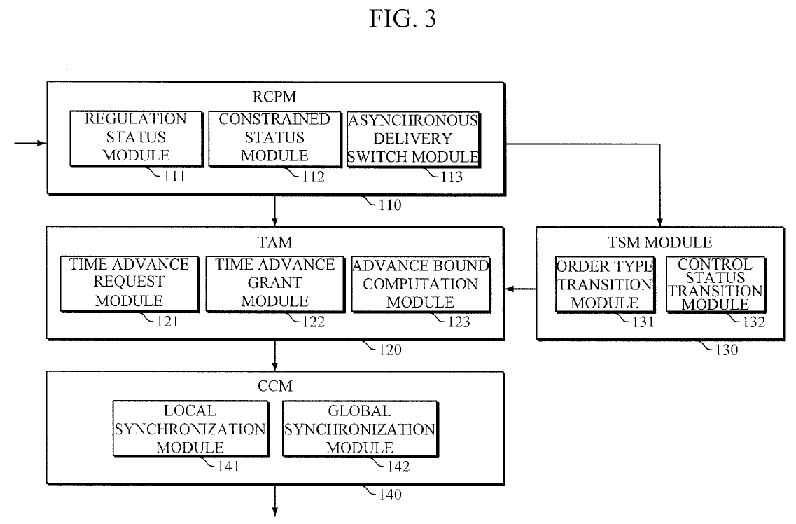

FIG. 3 is a block diagram illustrating a time manager of a gateway according to an exemplary embodiment.

Referring to FIG. 3, the time manager 100 includes a regulation-and-constrained policy module (RCPM) 110, a time advance module (TAM) 120, a temporal state management (TSM) module 130, and a clock conversion module (CCM) 140.

The RCPM 110 determines policies for message transmission/reception according to time order of the federates participating in a federation. Here, the federates may be classified into regulation federates, constrained federates, and regulations and constrained federates. The RCPM 110 includes, specifically, a regulation status module 111 that manages a regulation status, a constrained status module 112 that manages a constrained status, and an asynchronous delivery switch module 113 that asynchronously transmits data.

The TAM 120 drives the HLA federates 10, 11, and 12 and the DDS participants 20, 21, and 22 to advance their times such that clocks of the HLA federates and DDS participants are synchronized to each other according to the policies determined by the RCPM 110 and thereby the HLA federates and DDS participants can exchange messages at designated times. That is, the federates participating in a federation issue a time advance request and process the time advancement in order to process the messages according to time stamp. The TAM 120 includes a time advance request module 121, a time advance grant module 122, and an advance bound computation module 123. The time advance request module 121 processes a time advance request from the federates. The time advance grant module 122 grants the federates the requested time advance. The advance bound computation module 123 calculates a bound of time to which the federates may advance.

The TSM module 130 tracks a temporal state when the TAM 120 advances time according to the policies determined by the RCPM 110, and then the TSM module 130 determines a message type according to the tracking result. That is, the TSM module 130 determines a message type according to the presence or absence of a time stamp at the time of exchanging messages between federates participating in a federation, the types of federates, and a type of sent messages. The TSM module 130 includes an order type transition module 131 for determining a message type and a control status transition module 132 for managing and monitoring the time control status.

The information determined by the TSM module 130 is delivered to the TAM 120, and the TAM 120 executes a proper operation by referencing the delivered information.

The CCM 140 supports the HLA federates 10, 11, and 12 and the DDS participants 20, 21, and 22 to convert their logical time according to time advance information transmitted from the TAM 120. The CCM 140 supports the HLA federates 10, 11, and 12 and the DDS participants 20, 21, and 22 to synchronize their time to a wall clock time of a clock federate of the gateway. Specifically, the CCM 140 includes a local synchronization module 141 and a global synchronization module 140. The local synchronization module 141 supports the HLA federates 10, 11, and 12 to synchronize their clocks to keep pace with the wall clock of the clock federate 30, and the global synchronization module 140 supports the DDS participants 20, 21, and 22 to synchronize their clocks to the wall clock of the clock federate 30.

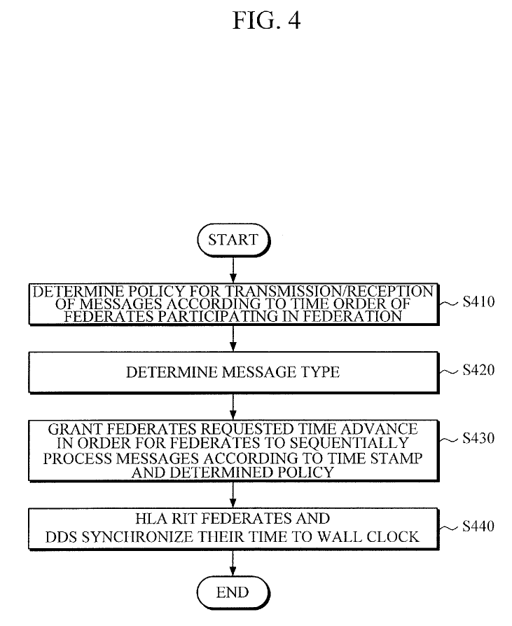

FIG. 4 is a flowchart illustrating a real-time synchronization method for supporting live-system interconnection a according to an exemplary embodiment.

Referring to FIG. 4 in conjunction with FIG. 1, the gateway 1 determines policies for transmission/reception of messages according to time order of HLA federates and DDS participants, as depicted in S410. At this time, the gateway 1 determines at least one of a regulation status, a constrained status, and whether to perform asynchronous-delivery switching.

The gateway 1 determines a type of message to be transmitted and received, as depicted in S420, according to the existence of a time stamp at the time of exchanging messages between federates participating in a federation, the types of federates, and a type of sent messages.

In S430, the gateway 1 grants the HLA federates and the DDS participants requested time advance in order to allow the HLA federates and the DDS participants to sequentially transmit and receive messages according to the determined policies. At this time, the gateway 1 calculates a bound of time to which the HLA federates and the DDS participants can advance, and then the gateway 1 controls the time advance according to the calculated bound of time.

The gateway 1 supports the conversion of logical time such that the HLA federates and the DDS participants can synchronize their time to a wall clock provided by a clock federate and thus they can be synchronized to each other, as depicted in S440. In one exemplary embodiment, the DDS participants deliver a wall clock time stamp using Liveliness protocol. The wall clock time stamp is contained in data octet in a Liveliness message.

The present invention provides a method for allowing DDS and HLA RTI federation, which are heterogeneous middleware, to exchange messages at synchronized times according to time order (the order of event occurrence) and thereby providing a real-time simulation in an LVC environment. A global time synchronization method using a clock federate, which improves the existing HLA time synchronization method that is impossible for real-time support, achieves real-time time synchronization that supports live-system interconnection.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A gateway for interconnection of heterogeneous middleware comprising:
a high level architecture (HLA) federate;
a data distribution service (DDS) participant;
a clock federate for a wall clock; and
a time manger configured to synchronize times of the HLA federate and the DDS participant to the wall clock provided by the clock federate.

2. The gateway of claim 1, wherein the time manager comprises a regulation-and-constrained policy module (RCPM) configured to determine policies for transmission/reception of messages according to time order of the HLA federate and the DDS participant,
a time advance module (TAM) configured to grant the HLA federate and the DDS participant their requested time advance in order to allow the HLA federate and the DDS participant to sequentially transmit and receive messages according to the policies determined by the RCPM, and
a clock conversion module (CCM) configured to support conversion of logical time such that the HLA federate and the DDS participant are synchronized with each other in response to a request from the TAM.

3. The gateway of claim 2, wherein the time manager further comprises a temporal state management (TSM) module configured to track a temporal state that varies according to processing of the TAM and to determine a type of message to be transmitted and received according to the tracking result, and the TAM controls a specific type of message determined by the TSM module to be transmitted and received.

4. The gateway of claim 2, wherein the RCPM determines at least one of a regulation status, a constrained status, and whether to perform asynchronous-delivery switching.

5. The gateway of claim 2, wherein the TAM comprises a time advance request module configured to process time advance requests from the HLA federate and the DDS participant, and a time advance grant module configured to grant the HLA federate and the DDS participant the requested time advance.

6. The gateway of claim 5, wherein the TAM further comprises an advance bound computation module configured to calculate a bound of time to which the federate and the DDS participant can advance, and the time advance grant module controls time advance according to the calculated bound of time.

7. The gateway of claim 3, wherein the TSM module comprises an order type transition module configured to determine a message type according to presence or absence of a time stamp for a message transmitted and received by the HLA federate and the DDS participant, a type of federate, and a type of transmitted message, and a control status transition module configured to manage and monitor a time control status.

8. The gateway of claim 2, wherein the CCM comprises a local synchronization module configured to support the FILA federate to keep pace with the wall clock of the clock federate, and a global synchronization module configured to support the DDS participant to synchronize its time to the wall clock of the clock federate.

9. The gateway of claim 1, wherein the DDS participant delivers a wall clock time stamp using Liveliness protocol, and the wall clock time stamp is contained in data octet in a Liveliness message.

10. A time synchronization method in a gateway for interconnection of heterogeneous middleware, the time synchronization method comprising:
determining policies for transmission/reception of messages according to time order of a high level architecture (HLA) federate and a data distribution service (DDS) participant;
granting the HLA federate and the DDS participant their requested time advance in order to allow the HLA federate and the DDS participant to sequentially transmit and receive messages according to the determined policies; and
supporting conversion of logical time to allow the HLA federate and the DDS participant to synchronize their time to a wall clock provided by a clock federate such that the HLA federate and the DDS participant are synchronized with each other.

11. The time synchronization method of claim 10, further comprising a message type according to presence or absence of a time stamp for a message transmitted and received by the HLA federate and the DDS participant, a type of federate, and a type of transmitted message,
wherein granting of the HLA federate and the DDS participant comprises controlling the determined type of message to be transmitted and received.

12. The time synchronization method of claim 10, wherein in the determining of the policies, at least one of a regulation status, a constrained status, and whether to perform asynchronous-delivery switching is determined.

13. The time synchronization method of claim 10, wherein the granting of the HLA federate and the DDS participant comprises calculating a bound of time to which the federate and the DDS participant can advance, and controlling time advance according to the calculated bound of time.

14. The time synchronization method of claim 10, wherein the supporting of the conversion of logical time comprises supporting the HLA federate to keep pace with the wall clock of the clock federate, and supporting the DDS participant to synchronize its time to the wall clock of the clock federate.

15. The time synchronization method of claim 10, wherein in the supporting of the conversion of logical time, the DDS participant delivers a wall clock time stamp using Liveliness protocol, and the wall clock time stamp is contained in data octet in a Liveliness message.
